(19) United States
(12) Patent Application Publication
(10) Pub. No.: US 2003/0041149 A1
(43) Pub. Date: Feb. 27, 2003

(54) Computer systems

(76) Inventor: Darren Ladds, Oxford (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/211,383

(22) Filed: Aug. 5, 2002

(30) Foreign Application Priority Data
Aug. 4, 2001 (GB) 0119121.2

(51) Int. Cl. G06F 15/16

(52) U.S. Cl. 709/227

(57) ABSTRACT

A computer system (1) comprising a first node (7 or 8) having a roaming user profile for a user, at least one other node (8 or 7) having a roaming user profile for the user; they system being configured whereby in a logged on session a change to the roaming user profile on one node is updated to the roaming user profile on another node of the system prior to a session log off. A method for updating a roaming user profile, and a computer node (2) for use in such a system are also disclosed.

### FIELD OF THE INVENTION

The present invention relates to computer systems, to associated methods of operating such systems and to computer nodes for such systems.

### BACKGROUND TO THE INVENTION

In a thin client environment a client node, typically a personal computer, operates as a graphical user interface (GUI) and input/output device for a user while processing and the saving of files etc is carried out on one or more servers.

However, as recognised in Microsoft (trade mark) technical note Q243535 such an architecture can give rise to problems in relation to roaming user profiles. The problem set out in technical note Q243535 is that when the same user profile is used for a Windows (trade mark) and a terminal services client, the profile may be inconsistent or be overwritten. Configuration changes made on a local Windows desktop can fail to overwrite the user profile stored on a terminal server, depending on which desktop is closed last. The same is true for multiple terminal services client sessions that use the same roaming user profile concurrently. For instance if a user is running a first application (eg EXCEL (trade mark)) on a first terminal server and a second application (eg WORD (trade mark)) on a second terminal server, a change to a roaming user profile, such as a drive mapping in the first application will not be registered in the user profile being used by the second application. So, if the first application is shut down before the session is logged-off, the change to the roaming user profile will not be saved in the terminal server user profile registry for the another session. It is only when the session is logged-off that changes to the roaming user profile are saved.

In the Microsoft technical note Q243535 it is recommended that roaming user profiles should not be used for terminal services (ie thin client) clients. However, this is an undesirable solution because it precludes the use of advantageous roaming user profiles.

The same problem can arise in non-thin client systems if a user is logged on to more than one server.

Accordingly it is an aim of preferred embodiments of the present invention to provide a computer system, a method of operating the same and a computer node for such a system, that obviate or overcome a problem associated with the prior art, whether referred to herein or otherwise.

### SUMMARY OF THE INVENTION

According to the present invention in a first aspect, there is provided a computer system comprising a first node having a roaming user profile for a user, at least one other node having a roaming user profile for the user; the system being configured whereby in a logged on session a change to the roaming user profile on one node is updated to the roaming user profile on another node of the system prior to a session log off.

By using the present invention the at least two roaming user profiles are forced to match.

By updating other nodes prior to session log off the problems referred to above can be avoided.

Suitably, the update is to a plurality of other nodes of the system on to which the user is logged on. Suitably, the update is to all other nodes of the system on to which the user is logged on.

Suitably, the system comprises an update agent configured to receive a roaming user profile change and to update another node of the system upon receipt thereof.

Suitably, the update agent comprises a log on agent configured to notify another agent that a user has logged on at a user node whereby the user node is updated with changes to the roaming user profile.

Suitably, the update agent comprises a registry filter agent configured to intercept changes to the roaming user profile on the node on which such changes have been made. Suitably, the registry filter element is configured to notify another agent of such changes.

Suitably, the update agent comprises a control agent configured to receive roaming user profile changes data from another agent and update the local roaming user profile accordingly. Suitably, the update agent comprises a control agent which receives roaming user profile changes data from the registry filter agent and passes the roaming user profile change data to a central control agent. Suitably, the update agent comprises a control agent which upon receipt of a notification from the log on agent requests roaming user profile changes for the node on to which a user is logging on according to the log on agent.

Suitably, the update agent comprises a central control agent configured to monitor which user or users is or are logged on to which user node or user nodes. Suitably, the central control agent is configured to receive roaming user profile changes from another agent and forward such to nodes in the system for local roaming user profile updates. Suitably, the central control agent maintain an at least temporary record of roaming user profile changes.

Suitably, the update agent comprises a log off agent whereby on a user log off it can be determined whether the user has logged off from all nodes, in which case the central control agent record is deleted.

Suitably, there are a plurality of server nodes.

Suitably, there is at least one server node for core applications and at least one backend server node for at least one other application. This is a three level (with the client node) environment.

Suitably, the update is carried out substantially simultaneously with the change to the roaming user profile.

Suitably, the first node is connected to the other node via a distributed electronic network. Suitably, the distributed electronic network is the internet. Alternatively, the distributed electronic network is a wide area network or a local area network.

Suitably, the computer system is a thin client computer system.

According to the present invention in a second aspect, there is provided a method for updating a roaming user profile in a computer system comprising a first node having a roaming user profile of a user and another node having a roaming user profile of the user; the method comprising the step of in a logged on session upon a change being made to the roaming user profile on one node, updating the roaming user profile on another node of the system prior to session log off.

Suitably, the method comprises the steps of an update agent receiving a roaming user profile change and updating another node of the system upon receipt thereof.

Suitably, the update agent comprises a log on agent to notify another agent that a user has logged on at a user node whereby the user node is updated with changes to the roaming user profile.

Suitably, the update agent comprises a registry filter agent to intercept changes to the roaming user profile on the node on which such changes have been made. Suitably, the registry filter element notifies another agent of such changes.

Suitably, the update agent comprises a control agent to receive roaming user profile changes data from another agent and update the local roaming user profile accordingly. Suitably, the update agent comprises a control agent which receives roaming user profile changes data from the registry filter agent and passes the roaming user profile change data to a central control agent. Suitably, the update agent comprises a control agent which upon receipt of a notification from the log on agent requests roaming user profile changes for the node on to which the user is logging on according to the log on agent.

Suitably, the update agent comprises a central control agent to monitor which user or users is or are logged on to which user node or user nodes. Suitably, the central control agent receives roaming user profile changes from another agent and forwards such to nodes in the system for local roaming user profile updates. Suitably, the central control agent maintains an at least temporary record of roaming user profile changes.

Suitably, the update agent comprises a log off agent whereby on a user log off it can be determined whether the user has logged off from all nodes, in which case the central control agent record is deleted.

Suitably, there are a plurality of server nodes.

Suitably, there is at least one server node for core applications and at least one backend server node for at least one other application. This is a three level (with the client node) environment.

Suitably, the update is carried out substantially simultaneously with the change to the roaming user profile.

Suitably, the first node is connected to the other node via a distributed electronic network. Suitably, the distributed electronic network is the internet. Alternatively, the distributed electronic network is a wide area network or a local area network.

Suitably, the computer system is a thin client computer system.

According to the present invention in a third aspect, there is provided a computer node configured for use in a distributed computer system in which a user can have a roaming user profile on the computer node and a roaming user profile on another computer node, the computer node being configured whereby in a logged on session a change to a roaming user profile on the computer node generates a signal for updating a roaming user profile on another node of a computer system prior to session log off.

The computer node can be adapted for the computer system according to the first aspect of the present invention.

### BRIEF DESCRIPTION OF THE DRAWINGS

The present invention will now be described, by way of example only, with reference to the drawings that follow; in which:

FIG. 1 is a schematic illustration of a three tiered thin client environment.

FIG. 2 is a schematic illustration of agents of the update agent of FIG. 1.

FIG. 3 is a functional flow diagram illustrating a method according to the present invention.

### DESCRIPTION OF PREFERRED EMBODIMENTS

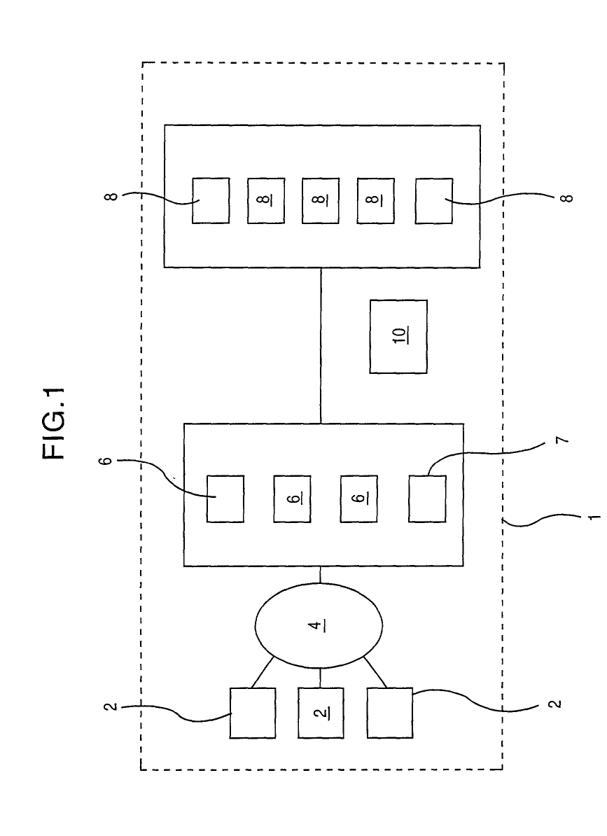

Referring to FIG. 1 of the drawings that follow, there is shown a thin client environment 1, comprising a user node 2 (the client node) computer terminal connected across a distributed electronic network 4, such as the internet, to a plurality of Windows terminal server nodes 6, which in turn are connected by a local area network (LAN) to a plurality of back-end server nodes 8. The thin client computer system further comprises an update agent indicated schematically at 10. The update agent 10 consists of several other agents distributed about the system.

In this environment, to avoid running either unstable or resource intensive applications on a main application desktop terminal server form, a 3-tiered implementation is shown. It should be noted however that the present invention is equally applicable to a 2-tiered implementation comprising the user node 2 and terminal server nodes 6. The 3-tiered implementation allows users to access the required unstable or resource intensive application without impacting significantly on other users on the same system. This also increases the stability of the terminal server nodes 6.

User node 2 may be connected directly to backend server nodes 8.

In this environment, a roaming user profile is stored in a profile server node 7 of the terminal server nodes 6. Normally the profile server node 7 is not used as a terminal server node 6, though this can be the case. A roaming user profile is a set-up configuration for a user, stored on a central server node (the profile server node 7) for transfer to a node used by the user. When a user logs on to a session using an application on a backend server node 8 their roaming user profile is transferred to the relevant backend server 8 and stored locally. Typically roaming user files are stored in a file “ntuser.dat” on each node, one for every user. When a second or further application is or are opened on a node on which the user is already logged on, the roaming user profile is available from the local ntuser.dat file on that node.

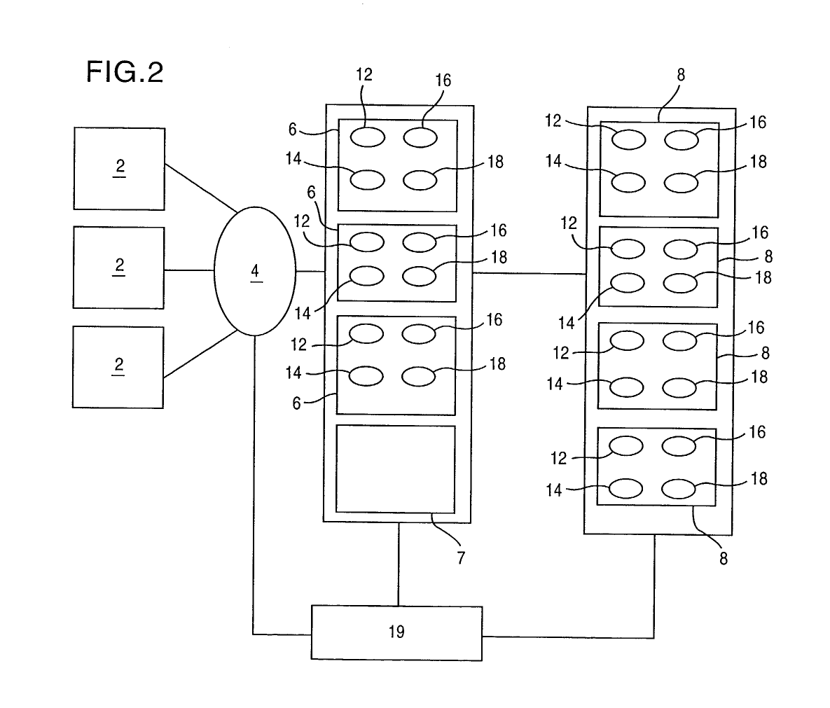

Referring to FIG. 2 of the drawings that follow the update agent 10 comprises a log on agent 12, a registry filter agent 14, a control agent 16, a central control agent 18 and a log off agent 20. Each agent 12-20 is implemented as computer software in the thin client environment.

Log on agent 12 is installed on each sever node 6, 8. It is executed early in the log on process. Log on agent 12 performs two roles: a) it notifies the central control agent 18 (via control agent 16) that a user has just logged on to a particular user node 2 (the user is identified by an unique identification string); and b) waits for all registry changes from the central control agent 18 that the user has made to a roaming user profile on another node in the thin client environment to be updated on the server node 6, 8 on which the user is logging on. In this way synchronising the two profiles substantially simultaneously, ie before the user has had the opportunity to make further changes to the roaming user profile. There can be a longer delay, but the arrangement described above is preferable.

Registry filter agent 14 is installed on every server node 6, 8 in the thin client environment (or at least to every node on which a given user may have a roaming user profile). The registry filter agent 14 intercepts writes to the local cache profile registry (to HKEY_USERS in a WINDOWS operating system) and passes these to the control agent 16.

The control agent 16 is also installed on every server node 6, 8 in the thin client environment (or at least on to every node on which a given user may have a roaming user profile). The control agent 16 performs several roles: a) it receives registry data (ie changes to a roaming user profile) from the registry filter agent 14 and passes this data to the central control agent 18; b) it receives registry data (ie changes to a roaming user profile) to write to the local cache profile registry (ie HKEY_USERS key in WINDOWS) on that node; c) upon receipt of a log on notification from log on agent 12, the control agent 16 sends the log on data to central control agent 18; and d) control agent 16 receives and passes to central control agent 18 log off notifications from log off agent 20.

The central control agent 18 is a dedicated computer node 19 that sits somewhere within the thin client environment, in communication with the relevant other agents. The central control agent 18 performs four roles: a) it keeps internal records of which user is logged on and to which nodes within the thin client environment they are logged on to; b) it receives registry data from the control agents 16; c) it relays the registry data (roaming user profile updates) to other control agents 16; and d) it stores all registry data (roaming user profile updates) in an internal data store for transmittal to the relevant node 6, 8 on to which a user logging on in response to a log on notification from a log on agent 12 (via control agent 16).

Log off agent 20 is installed on every server node 6, 8 and is executed during any node log off process. The log off agent 20 informs the central control agent 18 (via the control agent 16) that a user has logged off and that the roaming user profile on the backend profile server has been updated with all current changes. At this point the central control agent 18 can now determine whether to delete the internal data store (ie roaming user profile update history) for the user dependent on whether all changes have been written back to the profile server 7. This determination depends on whether the user is also logged on to another node (or is logging on to a node) in the thin client environment, in which case further changes could be made so the internal data store would not be deleted.

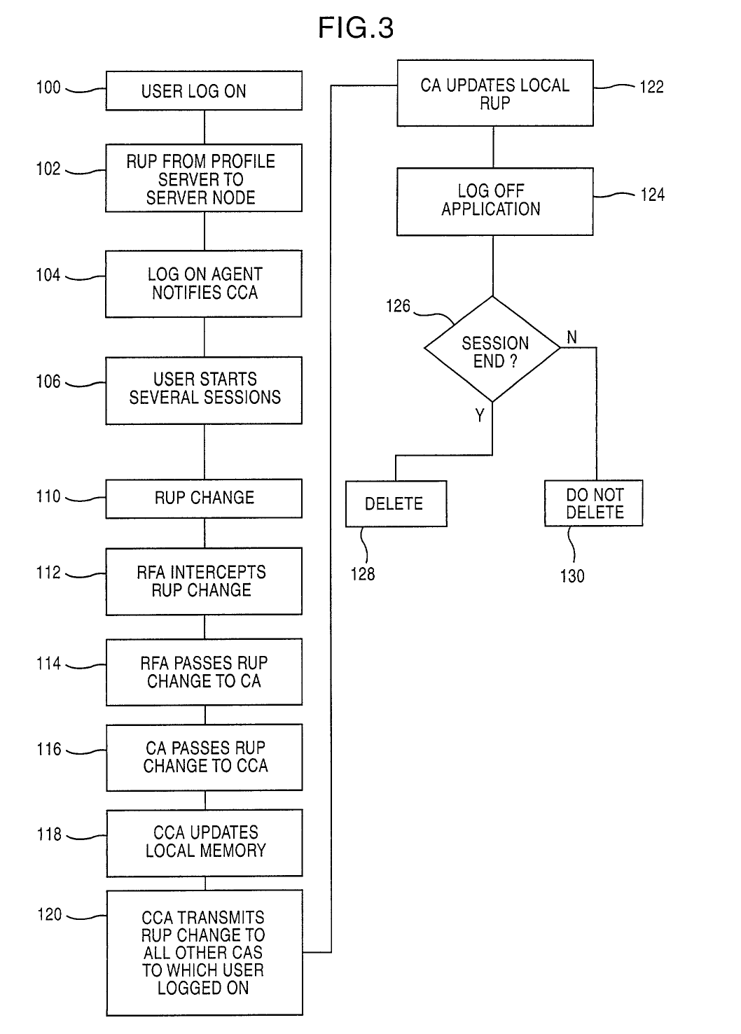

Referring additionally to FIGS. 3 of the drawings that follow, a method for updating a roaming user profile is described.

In step 100 a user logs on to a new thin client session at a user node 2 on a server 6 or 8, creating a logged on session. A roaming user profile (RUP) is then transferred from a profile node 7 to the particular sever node 6 or 8 (step 102). The log on agent 12 on this particular server 6 or 8 on to which the user is logging on notifies the central control agent 18 (CCA) (via the control agent 16) that a user has logged on to a particular server node 2 (step 104).

Once logged on to a server 6 or 8 the user can run applications on that server. If the user wishes to run an application on another server 6 or 8 (usually determined by the thin client system not the user) the steps 100, 102 and 104 occur as a log on to that new server 6 or 8.

In step 110 the user changes an aspect of its roaming user profile on a server 6 or 8 running an application.

The instruction to change the roaming user profile is intercepted by registry filter agent 14 (RFA) on the particular server node (step 112) and passed to control agent 16 (CA) on that node (step 114). The control agent 16 receives the roaming user profile change from registry filter agent 14 and passes it to central control agent 18 (CCA) (step 116). The central control agent 18 receives the data from control agent 16 and updates its local memory with the roaming user profile change (step 118). The central control agent 18 then relays the roaming user profile change to all the relevant control agents 16 (step 120); that is to server nodes on to which the user is logged on. Upon receipt of the new roaming user profile change information, each local control agent 16 updates it's corresponding local cache roaming user profile accordingly (step 122).

The method described above happens substantially simultaneously with the initial roaming user profile change as it is intercepted locally ie on the node at which the change is generated.

In step 124 the user logs off completely from a particular node (ie session end). In step 126 the log off agent 20 notifies the central control agent 18 (via control agent 16) of the session log off by a given user. If according to the relevant counter the CCA 18 determines that all session for that user have been logged off the central control agent 18 deletes its local store of changes written to the profile server 7 (step 128). If the user is still logged on at another node the local record is not deleted (step 130). The data stored in CCA 18 is deleted once it has been confirmed that all data in CCA 18 has been written to profile server 7.

Thus, whenever the profile server 7 is updated with the roaming user profile it is current because the roaming user profiles for all nodes on to which the user is logged on are forced to match. Changes to roaming user profiles are intercepted and sent to all other nodes on to which the user is logged on as soon as the change is made on a node, that is before a session log off.

The same technique can be used for non-thin client systems on which a user is logged on to at least two nodes in a computer network.

It will be appreciated that although the preferred embodiment of the present invention is described in relation to implementation on a Windows terminal server environment, the invention is equally applicable to other thin client applications using roaming user profiles, such as Citrix Winframe (trade mark).

It will be appreciated that in a thin client environment the terminal servers will be connected to and, together with the backend servers, will service a multiplicity of user nodes substantially simultaneously.

The update agent is implemented using computer software within the ambit of a person skilled in the art, based on the teaching of the present specification. The agents are executed by processors in computer nodes.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A computer system comprising a first node having a roaming user profile for a user, at least one other node having a roaming user profile for the user; they system being configured whereby in a logged on session a change to the roaming user profile on one node is updated to the roaming user profile on another node of the system prior to a session log off.

2. A computer system as claimed in claim 1, wherein the system comprises an update agent configured to receive a roaming user profile change and to update another node of the system upon receipt thereof.

3. A computer system as claimed in claim 2, wherein the update agent comprises a log on agent configured to notify another agent that a user has logged on at a user node whereby the user node is updated with changes to the roaming user profile.

4. A computer system as claimed in claim 2, wherein the update agent comprises a registry filter agent configured to intercept changes to the roaming user profile on the node on which such changes have been made.

5. A computer system as claimed in claim 4, wherein the registry filter element is configured to notify another agent of such changes.

6. A computer system as claimed in claim 2, wherein the update agent comprises a control agent configured to receive roaming user profile changes data from another agent and update the local roaming user profile accordingly.

7. A computer system as claimed in claim 2, wherein the update agent comprises a control agent which receives roaming user profile changes data from the registry filter agent and passes the roaming user profile change data to central control agent.

8. A computer system as claimed in claim 2, wherein the update agent comprises a control agent which upon receipt of a notification from the log on agent requests roaming user profile changes for the node on to which a user is logging on according to the log on agent.

9. A computer system as claimed in claim 2, wherein the update agent comprises a central control agent configured to monitor which user or users is or are logged on to which user node or user nodes.

10. A computer system as claimed in claim 9, wherein the central control agent is configured to receive roaming user profile changes from another agent and forward such to nodes in the system for local roaming user profile updates.

11. A computer system as claimed in claim 9, wherein the central control agent maintains an at least temporary record of roaming user profile changes.

12. A computer system as claimed in claim 9, wherein the update agent comprises a log off agent whereby on a user log off from all nodes, in which case the central control agent record is deleted.

13. A computer system as claimed in claim 1, wherein there are a plurality of server nodes.

14. A computer system as claimed in claim 13, wherein there are at least one server node for core applications and at least one backend server node for at least one other application.

15. A computer system as claimed in claim 1, wherein the update is carried out substantially simultaneously with the change to the roaming user profile.

16. A computer system as claimed in claim 1, wherein the update is to a plurality of other nodes of the system on to which the user is logged on.

17. A computer system as claimed in claim 16, wherein the update is to all other nodes of the system on to which the user is logged on.

18. A computer system as claimed in claim 1, wherein the first node is connected to the other node via a distributed electronic network.

19. A computer system as claimed in claim 18, wherein the distributed electronic network is the internet.

20. A computer system as claimed in claim 18, wherein the distributed electronic network is a wide are network or a local area network.

21. A computer system as claimed in claim 1, wherein the computer system is a thin client computer system.

22. A method for updating a roaming user profile in a computer system comprising a first node having a roaming user profile of a user and another node having a roaming user profile of the user; the method comprising the step of in a logged on session upon a change being made to the roaming user profile on one node, updating the roaming user profile on another node of the system prior to session log off.

23. A method for updating a roaming user profile in a computer system as claimed in claim 22, wherein the method comprises the steps of an update agent receiving a roaming user profile change and updating another node of the system upon receipt thereof.

24. A method for updating a roaming user profile in a computer system as claimed in claim 23, wherein the update agent comprises a log on agent to notify another agent that a user has logged on at a user node whereby the user node is updated with changes to the roaming user profile.

25. A method for updating a roaming user profile in a computer system as claimed in claim 23, wherein the update agent comprises a registry filter agent to intercept changes to the roaming user profile on the node on which such changes have been made.

26. A method for updating a roaming user profile in a computer system as claimed in claim 25, wherein the registry filter element notifies another agent of such changes.

27. A method for updating a roaming user profile in a computer system as claimed in claim 23, wherein the update agent comprises a control agent to receive roaming user profile changes data from another agent and update the local roaming user profile accordingly.

28. A method for updating a roaming user profile in a computer system as claimed in claim 23, wherein the update agent comprises a control agent which receives roaming user profile changes data from the registry filter agent and passes the roaming user profile change data to a central control agent.

29. A method for updating a roaming user profile in a computer system as claimed in claim 23, wherein the update agent comprises a control agent which upon receipt of a notification from the log on agent requests roaming user profile changes for the node on to which the user is logging on according to the log on agent.

30. A method for updating a roaming user profile in a computer system as claimed in claims 23, wherein the update agent comprises a central control agent to monitor which user or users is or are logged on to which user node or user nodes.

31. A method for updating a roaming user profile in a computer system as claimed in claim 30, wherein the central control agent receives roaming user profile changes from another agent and forwards such to nodes in the system for local roaming user profile updates.

32. A method for updating a roaming user profile in a computer system as claimed in claim 31, wherein the central control agent maintains an at least temporary record of roaming user profile changes.

33. A method for updating a roaming user profile in a computer system as claimed in claim 30, wherein the update agent comprises a log off agent whereby on a user log off it can be determined whether the user has logged off from all nodes, in which case the central control agent record is deleted.

34. A method for updating a roaming user profile in a computer system as claimed in claim 22, wherein there are a plurality of server nodes.

35. A method for updating a roaming user profile in a computer system as claimed in claim 34, wherein there is at least one server node for core applications and at least one backend server node for at least one other application.

36. A method for updating a roaming user profile in a computer system as claimed in claim 22, wherein the update is carried out substantially simultaneously with the change to the roaming user profile.

37. A method for updating a roaming user profile in a computer system as claimed in claim 22, wherein the first node is connected to the other node via a distributed electronic network.

38. A method for updating a roaming user profile in a computer system as claimed in claim 37, wherein the distributed electronic network is the internet.

39. A method for updating a roaming user profile in a computer system as claimed in claim 37, wherein the distributed electronic network is a wide are network or a local area network.

40. A method for updating a roaming user profile in a computer system as claimed claim 22, wherein the computer system is a thin client computer system.

41. A computer node configured for use in a distributed computer system in which a user can have a roaming user profile on the computer node and a roaming user profile on another computer node, the computer node being configured whereby in a logged on session a change to a roaming user profile on the computer node generates a signal for updating a roaming user profile on another node of a computer system prior to session log off.
